(19) United States
(12) Patent Application Publication
(10) Pub. No.: US 2004/0199906 A1
(43) Pub. Date: Oct. 7, 2004

(54) Systems and methods for saving files having different media types

(76) Inventors: Russell F. McKnight, Sioux City, IA (US); Glen J. Anderson, Sioux City, IA (US)

Correspondence Address: Gateway, Inc., Scott Charles Richardson, 605 Gateway Drive, MD Y-04, N. Sioux City, SD, 57049, US

(21) Appl. No.: 10/404,840

(22) Filed: Apr. 1, 2003

(51) Int. Cl. G06F 9/44

(52) U.S. Cl. 717/136; 717/137; 717/110

(57) ABSTRACT

Systems and methods for saving data in a variety of different media types are described. The systems and methods receive source data having a source media type. The source data is converted to a destination media type and output. Representative conversions include converting video and audio presentations to text based files, converting multiple segments of a video source into individual image files, and assembling multiple input files having differing media types into a single media type such as a slide presentation or video file.

### FIELD

The present invention relates to computerized software applications, and more particularly to saving files created in such applications to a differing media type.

### BACKGROUND

The number and types of computer software applications have grown as computer hardware, software, and development techniques have improved. For example, early computers could process text, but typically did not process images or audio. As computers became more powerful, image processing software became more common. Later, still more powerful computers made video and audio processing possible. As each of these capabilities became possible, many different applications were developed to meet user needs.

Each of these applications typically deals with a particular media type. For example, a word processing application is typically specialized to handle text files. An image processing application is typically specialized to handle files containing a static image. Video processing software is typically specialized to handle files having animated, or moving images along with accompanying audio. Thus, while each type of application may be able to convert between files within its media type, to date they have not been capable of converting between media types. For example, a word processing application may be able to convert between files having a format such as plain text, Microsoft Word, or Corel WordPerfect. Similarly, an image processing program may be able to convert between files having a JPEG format, a GIF format, or a BMP (bit map) format.

### SUMMARY

The proliferation of media types and formats has been problematic for many users since applications are not typically able to convert between media types. For example, a video processing application is not typically able to convert a multimedia file to a text file. It is common for files to be exchanged between users by email or on web sites. Oftentimes a user receiving a file does not have the application used to create the file. As a result, the user is not able to make use of the file. In view of the problems and issues noted above, there is a need in the art for the present invention.

The above-mentioned shortcomings, disadvantages and problems are addressed by the present invention, which will be understood by reading and studying the following specification.

Embodiments of the invention receive data having a source media type and save data having a destination media type. The source data is converted to a destination media type and saved, typically to a file. Representative conversions include converting video and audio presentations to text based files and converting text data to image data.

A further aspect of the embodiments of the invention includes converting multiple segments of a video source into individual image files.

A still further aspect of the embodiments includes assembling multiple input files having differing media types into a single media type such as a slide presentation or video file.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of the logical components of a system that incorporates embodiments of the invention.

FIGS. 2A-2C are flowcharts illustrating methods for saving source data according to various embodiments of the invention.

FIG. 3 is an architectural block diagram of the computer system utilizing the current invention.

### DETAILED DESCRIPTION

In the following description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

For the purposes of this specification, the term “media type” will be used to identify a generalized class or presentation mode of data, such as text data, image data, audio data, video data, or slide presentation. This is distinguished from media format, which will be used to identify a specific format within a media type. For example, a media format for a text file may be a file formatted by the Microsoft Word, or Corel WordPerfect word processing programs. Similarly, a media format for an image file could be a file formatted according to the JPEG, GIF or Microsoft “.bmp” file standards.

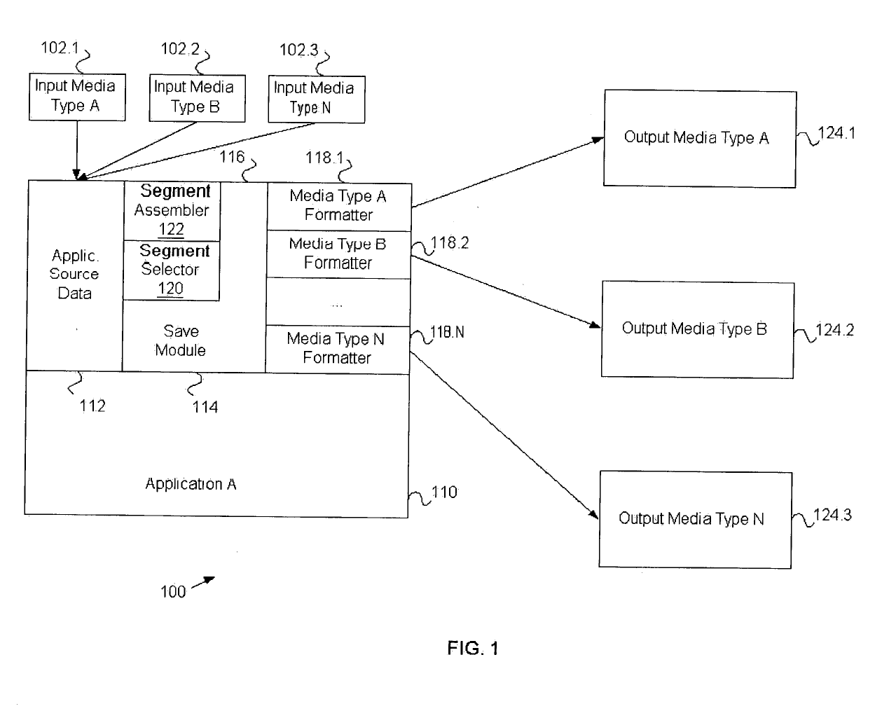

FIG. 1 is a block diagram of an exemplary system 100 incorporating embodiments of the invention for saving application data. System 100 includes application 110, which may receive one or more input data streams 102 and generate one or more output data streams 124. Input data streams 102 and output data streams 124 will typically be data files, however they may also be data streams received or sent to a network such as a local area network, a company intranet, a wide area network, or the Internet. Additionally, in some embodiments, input data streams 102 and output data streams 124 have a media type associated with them. For example, the data streams may have a media type of text data, image data, audio data, video data (which may include video data accompanied by audio data), and slide presentation data.

Application 110 may receive data from one or more of input data streams 102 and store the data internally as application source data 112 during processing. Application 110 may be specialized to process one input media type, or it may process more than one input media type.

In some embodiments, application 110 includes save module 114. A save module, such as the save module 114, is a module—that is a program, routine, set of instructions, compilation of software, or the like—which is invoked to save a version of application source data. For example, a user of application 110 invokes the save module 114 when the user desires to save a version of application source data 112. Save module 114 operates to generate an output data stream for application source data 112. In some embodiments of the invention, save module 114 invokes a formatting module 118 in order to generate an output data stream having the desired media type and media format. The desired output media type and format may be different than the input media type and format.

Examples of the operation of the above-described system will now be provided. In one example, application source data 112 may have a media type of video data. During the viewing of the video, the user may click a button to invoke save module 114 and indicate that the data should be saved as a report having a text media type, for example in Microsoft Word. In some embodiments, the format module 118 converts any audio data (e.g. voice-over) or graphical text in the video data into regular text (e.g. ASCII text or Unicode text).

Some embodiments include a segment selector which is a module used to select segments for conversion. In some embodiments the segment selector is configured as a stand-alone module while in other embodiments the segment selector is configured as part of another module. For example, save module 114 includes segment selector 120 that may be used to select segments for conversion. In some embodiments, segment selector 120 selects a frame that appears near each group of discovered text and saves representative frames as image data, for example as a JPEG. The text and graphics may then be saved to a file having a Microsoft Word document format and may be opened for the user to view. Segment selection may be driven by a number of factors in alternative embodiments of the invention, as will be described in further detail below.

Some embodiments include a segment assembler which is a module for assembling two or more segments into a single output data stream. In some embodiments the segment selector is configured as a stand-alone module, while in other embodiments the segment selector is configured as part of another module. For example, the application 110 is shown including segment assembler 122. Segment assembler 122 operates to assemble two or more segments into a single output data stream. The input segments 102 may have different media types. For example, a user may desire to create a timeline-based story or presentation that can be published to a variety of output data streams 124 for differing applications. For instance, input media types 102 may comprise a combination of video clips, still photographs, graphics, MP3 sound files and text to be arranged along a time line using segment assembler 122. Then the user may choose a variety of differing output media types 124 to publish the presentation. Examples of such presentations include a slide presentation using Microsoft Power Point, an MPEG movie using Adobe Premier or a web presentation using Macromedia Flash. In these embodiments, segment assembler 122 of application 110 converts the timeline into the chosen output media types and formats.

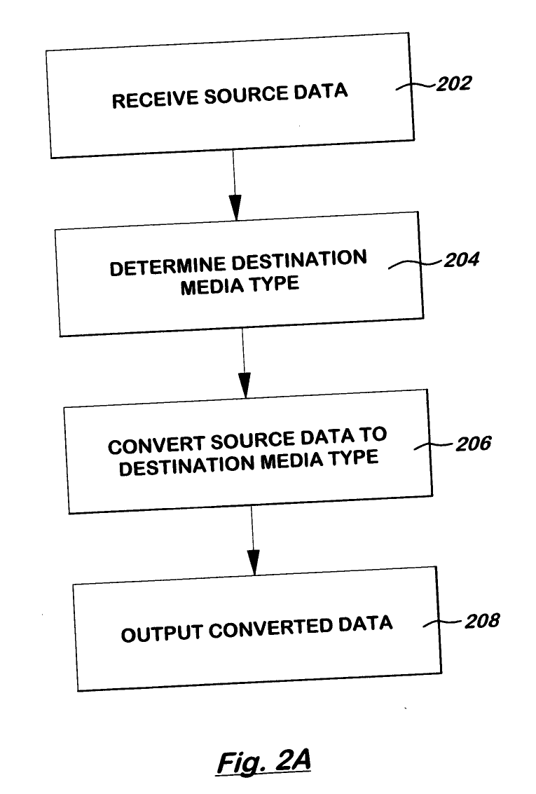

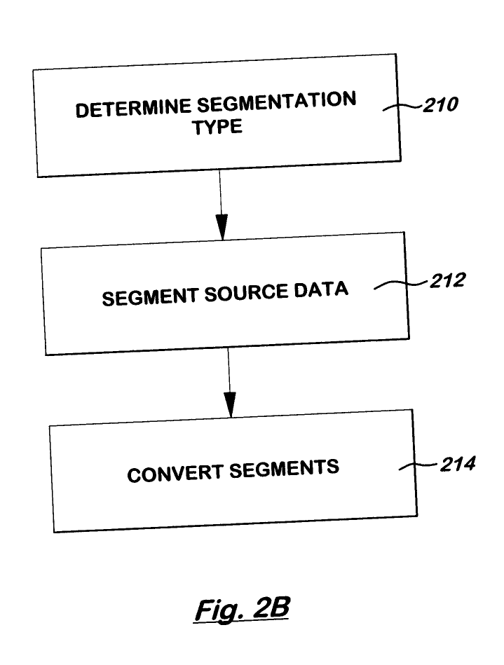

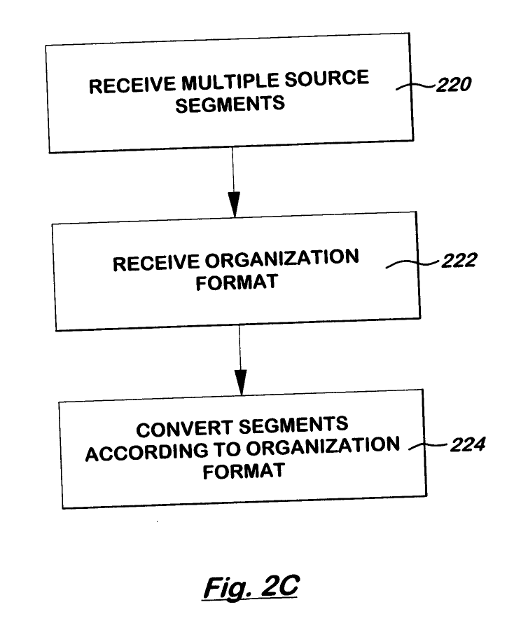

In the previous section, a system level overview of the operation of exemplary embodiment of the invention was described. In this section, the particular methods of the invention performed by an operating environment executing an exemplary embodiment are described by reference to a series of flowcharts shown in FIGS. 2A-2C. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from computer-readable media). The methods illustrated in FIGS. 2A-2C are inclusive of the acts performed by an operating environment executing an exemplary embodiment of the invention.

FIG. 2A is a flowchart illustrating a method for saving data according to an embodiment of the invention. A system executing the method, for example application 110, begins by receiving source data that is to be saved (block 202). The source data may be from a single source or it may comprise multiple sources. The source data has one or more media types associated with it. Examples of such media types as noted above include text data, image data, video data, audio data, and slide presentation data. The invention is not limited to any particular media type.

Next, in some embodiments the system receives a destination media type (block 204). The destination media type may be user specified, or it may be a default destination media type. In some embodiments, the destination media type is different from the source media type.

The system then converts the source data according to the destination media type (block 206). The conversion will depend on the source media type and the destination media type. For example, for video data that is to be converted to text data, the video data may be scanned for text appearing in a graphical format which is then converted to a text format. Additionally, voice data in the video may be converted using known speech to text conversion. In the case of audio data, speech to text conversion may be applied to convert the audio to text. For text data that is to be converted to image data, text may be converted to graphical text in a JPEG or GIF format. In some embodiments, the text may be segmented as described below, with one paragraph of text appearing in an individual JPEG or GIF file.

Next, the system outputs the converted source data (block 208). The output may be to a file, or it may be to a network data stream.

FIG. 2B is a flowchart illustrating a method according to an embodiment of the invention for segmenting source data into a plurality of segments for conversion and output. The method begins by determining a segmentation type (block 210). The segmentation type may be defaulted, or a user may select a segmentation type. Examples of segmentation types include segmenting based on significant changes in a scene in a video, pauses or gaps in an audio presentation, appearance of text in a video presentation, paragraph indicators, etc. The invention is not limited to any particular segmentation type.

Next, the method segments the source data according to the segmentation type (block 212). For example, if the user desires to segment based on gaps in audio, the source data (video with audio or audio only) is scanned and gaps or pauses in the source data cause a new segment to be created. Similarly, if the user has designated a scene change as the segmentation type, the source data is scanned to determine where significant scene changes occur. At these points, in some embodiments of the invention a representative frame from the scene is selected for output.

Next, the method converts the segment for output in the desired media type and format (block 214).

FIG. 2C is a flowchart illustrating a method for assembling segments having one or more media types into an output data stream having a differing media type. The method begins by receiving two or more segments to be assembled (block 220). The segments may comprise individual files, each having a media type. For example, the input segments may be individual image files, video files, audio files and/or text files or any combination thereof.

Next, in some embodiments, the system receives an organization for the input segments (block 222). In some embodiments, the organization will comprise a time line indicating the order of the segments.

The input segments are then converted into the desired destination media type (block 224). As an example, the source media types may include video, audio, image and text data. In some embodiments, the destination media type may be a slide presentation or a video data type. The segments are converted in the order specified by the organization format specified at block 222 and output as the desired media type. Thus if the desired output is a slide presentation, each segment is converted to a slide depending on the source media type. For example, representative images are selected from video data and converted to slides. Audio data may be converted to a text format for placement in a slide. Similarly, image data may be placed in a slide. Text data may also be converted into a slide format. The individual slides are then assembled into a slide presentation such as a Microsoft PowerPoint presentation.

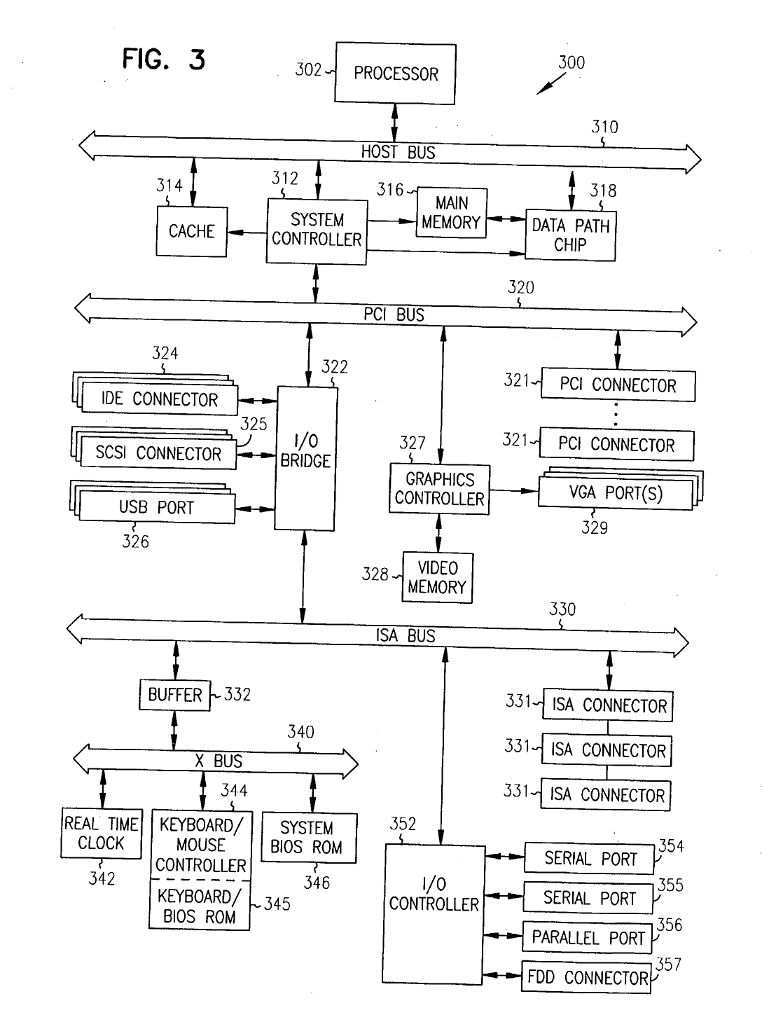

FIG. 3 is a block diagram of a computer system 300 that runs software programs, such as application program 110 that may save data using different media type than the source data. In some embodiments, computer system 300 comprises a processor 302, a system controller 312, a cache 314, and a data-path chip 318, each coupled to a host bus 310. Processor 302 is a microprocessor such as a 486-type chip, a Pentium®D, Pentium® II, Pentium® III, Pentium® 4, or other suitable microprocessor. Cache 314 provides high-speed local-memory data (in one embodiment, for example, 512 kB of data) for processor 302, and is controlled by system controller 312, which loads cache 314 with data that is expected to be used soon after the data is placed in cache 314 (i.e., in the near future). Main memory 316 is coupled between system controller 312 and data-path chip 318, and in one embodiment, provides random-access memory of between 16 MB and 256 MB or more of data. In one embodiment, main memory 316 is provided on SIMMs (Single In-line Memory Modules), while in another embodiment, main memory 316 is provided on DIMMs (Dual In-line Memory Modules), each of which plugs into suitable sockets provided on a motherboard holding many of the other components shown in FIG. 3. Main memory 316 includes standard DRAM (Dynamic Random-Access Memory), EDO (Extended Data Out) DRAM, SDRAM (Synchronous DRAM), or other suitable memory technology. System controller 312 controls PCI (Peripheral Component Interconnect) bus 320, a local bus for system 300 that provides a high-speed data path between processor 302 and various peripheral devices, such as graphics devices, storage drives, network cabling, etc. Data-path chip 318 is also controlled by system controller 312 to assist in routing data between main memory 316, host bus 310, and PCI bus 320.

In one embodiment, PCI bus 320 provides a 32-bit-wide data path that runs at 33 MHz. In another embodiment, PCI bus 320 provides a 64-bit-wide data path that runs at 33 MHz. In yet other embodiments, PCI bus 320 provides 32-bit-wide or 64-bit-wide data paths that run at higher speeds. In one embodiment, PCI bus 320 provides connectivity to I/O bridge 322, graphics controller 327, and one or more PCI connectors 321 (i.e., sockets into which a card edge may be inserted), each of which accepts a standard PCI card. In one embodiment, I/O bridge 322 and graphics controller 327 are each integrated on the motherboard along with system controller 312, in order to avoid a board-connector-board signal-crossing interface and thus provide better speed and reliability. In the embodiment shown, graphics controller 327 is coupled to a video memory 328 (that includes memory such as DRAM, EDO DRAM, SDRAM, or VRAM (Video Random-Access Memory)), and drives VGA (Video Graphics Adaptor) port 329. VGA port 329 can connect to industry-standard monitors such as VGA-type, SVGA (Super VGA)-type, XGA-type (eXtended Graphics Adaptor) or SXGA-type (Super XGA) display devices.

In one embodiment, graphics controller 327 provides for sampling video signals in order to provide digital values for pixels. In further embodiments, the video signal is provided via a VGA port 329 to an analog LCD display.

Other input/output (I/O) cards having a PCI interface can be plugged into PCI connectors 321. Network connections providing video input are also represented by PCI connectors 321, and include Ethernet devices and cable modems for coupling to a high speed Ethernet network or cable network which is further coupled to the Internet.

In one embodiment, I/O bridge 322 is a chip that provides connection and control to one or more independent IDE or SCSI connectors 324-325, to a USB (Universal Serial Bus) port 326, and to ISA (Industry Standard Architecture) bus 330. In this embodiment, IDE connector 324 provides connectivity for up to two standard IDE-type devices such as hard disk drives, CDROM (Compact Disk-Read-Only Memory) drives, DVD (Digital Video Disk) drives, videocassette recorders, or TBU (Tape-Backup Unit) devices. In one similar embodiment, two IDE connectors 324 are provided, and each provide the EIDE (Enhanced IDE) architecture. In the embodiment shown, SCSI (Small Computer System Interface) connector 325 provides connectivity for up to seven or fifteen SCSI-type devices (depending on the version of SCSI supported by the embodiment). In one embodiment, I/O bridge 322 provides ISA bus 330 having one or more ISA connectors 331 (in one embodiment, three connectors are provided). In one embodiment, ISA bus 330 is coupled to I/O controller 352, which in turn provides connections to two serial ports 354 and 355, parallel port 356, and FDD (Floppy-Disk Drive) connector 357. At least one serial port is coupled to a modem for connection to a telephone system providing Internet access through an Internet service provider. In one embodiment, ISA bus 330 is connected to buffer 332, which is connected to X bus 340, which provides connections to real-time clock 342, keyboard/mouse controller 344 and keyboard BIOS ROM (Basic Input/Output System Read-Only Memory) 345, and to system BIOS ROM 346.

The integrated system performs several functions identified in the block diagram and flowcharts of FIGS. 1 and 2A-2C. Such functions are implemented in software in one embodiment, where the software comprises computer executable instructions stored on computer readable media such as disk drives coupled to connectors 324 or 325, and executed from main memory 316 and cache 314.

The invention can be embodied in several forms including computer readable code, or other instructions, on a computer readable medium. Computer readable medium is any data storage device that can store code, instructions or other data that can be thereafter be read by a computer system or processor. Examples of the computer readable medium include read-only memory, random access memory, CD-ROMs, magnetic storage devices or tape, and optical data storage devices. The computer readable medium can configured within a computer system, communicatively coupled to a computer, or can be distributed over network-coupled computer systems so that the computer readable code is stored and executed in a distributed fashion. The term computer readable medium is also used to represent carrier waves on which the software is transmitted.

### CONCLUSION

Systems and methods for saving application data have been described. The systems and methods described provide advantages over previous systems. For example, a software application incorporating the systems and methods of the present invention may save data in a different media type than that provided to the application. Thus the data may be viewed by a user that does not have the same application software as the user generating the data.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

What is claimed is:

1. A computerized system comprising:
a software application operable to maintain source data having a source media type; and
a save module operable to convert the source data to a destination media type and output the converted data;
wherein the source media type is different from the destination media type.

2. The system of claim 1, wherein the source media type comprises a video media type and the destination media type is selected from a group comprising: text, image, slide presentation and audio.

3. The system of claim 1, wherein the source media type comprises a text media type and the destination media type is selected from a group consisting of: video, image, slide presentation and audio.

4. The system of claim 1, wherein the source media type comprises a slide presentation and the destination media type is selected from a group consisting of: video, text, image and audio.

5. The system of claim 1, wherein the source media type comprises an image media type, and the destination media type is selected from a group consisting of: video, text, slide presentation, and audio.

6. The system of claim 1, wherein the source media type comprise an audio media type and the destination media type is selected from a group consisting of: video, text, slide presentation and image.

7. The system of claim 1, further comprising a segment selector operable to segment the source data into a plurality of segments and wherein the save module converts each segment from the source media type to the destination media type.

8. The system of claim 7, wherein the segment selector segments the source data based on a change in text.

9. The system of claim 7, wherein the segment selector segments the source data based on a change in a scene.

10. The system of claim 7, wherein the segment selector segments the source data based on a representative scene for a segment.

11. The system of claim 7, wherein the segment selector segments the source data based on a gap in an audio stream.

12. The system of claim 1, further comprising a segment assembler, wherein the source data comprises a plurality of source segments, and further wherein the save module is further operable to:
convert each source segment to a single destination media type; and
store the converted segments to a single destination file having the single destination media type.

13. The system of claim 12, wherein the plurality of source segments are arranged in a timeline.

14. The system of claim 12, wherein the plurality of source segments include source segments having differing media types.

15. A computerized method for saving source data, the method comprising:
receiving source data having a source media type;
converting the source data to a destination media type, the destination media type being different from the source media type;
saving the converted source data to a file having the destination media type.

16. The method of claim 15, wherein the source media type comprises a video media type and the destination media type is selected from a group comprising: text, image, slide presentation and audio.

17. The method of claim 15, wherein the source media type comprises a text media type and the destination media type is selected from a group consisting of: video, image, slide presentation and audio.

18. The method of claim 15, wherein the source media type comprises a slide presentation and the destination media type is selected from a group consisting of: video, text, image and audio.

19. The method of claim 15, wherein the source media type comprises an image media type, and the destination media type is selected from a group consisting of: video, text, slide presentation, and audio.

20. The method of claim 15, wherein the source media type comprise an audio media type and the destination media type is selected from a group consisting of: video, text, slide presentation and image.

21. The method of claim 15, further comprising segmenting the source data into a plurality of segments and wherein converting the source data includes converting at least a portion of the segment from the source media type to the destination media type.

22. The method of claim 21, wherein segmenting the source data comprises determining a change in a block of text.

23. The method of claim 21, wherein segmenting the source data includes determining a change in a scene.

24. The method of claim 21, wherein segmenting the source data includes determining a representative scene for a segment.

25. The method of claim 21, wherein segmenting the source data comprises determining a gap in an audio stream.

26. The method of claim 15, wherein the source data comprises a plurality of source segments, and wherein converting the source data comprises:
converting at least a portion of each source segment to a single destination media type; and
storing the converted segments to a single destination file having the single destination media type.

27. The method of claim 26, wherein the plurality of source segments are arranged in a timeline.

28. The method of claim 26, wherein the plurality of sources segments include source segments having differing media types.

29. A computer-readable medium having computer-executable instructions for performing a method for saving source data, the method comprising:
receiving source data having a source media type;
converting the source data to a destination media type, the destination media type being different from the source media type;
saving the converted source data to a file having the destination media type.

30. The computer-readable medium of claim 29, wherein the source media type comprises a video media type and the destination media type is selected from a group comprising: text, image, slide presentation and audio.

31. The computer-readable medium of claim 29, wherein the source media type comprises a text media type and the destination media type is selected from a group consisting of: video, image, slide presentation and audio.

32. The computer-readable medium of claim 29, wherein the source media type comprises a slide presentation and the destination media type is selected from a group consisting of: video, text, image and audio.

33. The computer-readable medium of claim 29, wherein the source media type comprises an image media type, and the destination media type is selected from a group consisting of: video, text, slide presentation, and audio.

34. The computer-readable medium of claim 29, wherein the source media type comprise an audio media type and the destination media type is selected from a group consisting of: video, text, slide presentation and image.

35. The computer-readable medium of claim 29, wherein the method further comprises segmenting the source data into a plurality of segments and wherein converting the source data includes converting at least a portion of the segment from the source media type to the destination media type.

36. The computer-readable medium of claim 35, wherein segmenting the source data comprises determining a change in a block of text.

37. The computer-readable medium of claim 35, wherein segmenting the source data includes determining a change in a scene.

38. The computer-readable medium of claim 35, wherein segmenting the source data includes determining a representative scene for a segment.

39. The computer-readable medium of claim 35, wherein segmenting the source data comprises determining a gap in an audio stream.

40. The computer-readable medium of claim 29, wherein the source data comprises a plurality of source segments, and wherein converting the source data comprises:
converting at least a portion of each source segment to a single destination media type; and
storing the converted segments to a single destination file having the single destination media type.

41. The computer-readable medium of claim 40, wherein the plurality of source segments are arranged in a timeline.

42. The computer-readable medium of claim 40, wherein the plurality of sources segments include source segments having differing media types.

43. A computer system comprising:
a processor;
a memory coupled to the processor;
a software application executed by the processor in the memory and operable to maintain source data having a source media type; and
a save module operable to convert the source data to a destination media type and output the converted data, wherein the source media type is different from the destination media type.

44. The system of claim 43, wherein the source media type comprises a video media type and the destination media type is selected from a group comprising: text, image, slide presentation and audio.

45. The system of claim 43, wherein the source media type comprises a text media type and the destination media type is selected from a group consisting of: video, image, slide presentation and audio.

46. The system of claim 42, wherein the source media type comprises a slide presentation and the destination media type is selected from a group consisting of: video, text, image and audio.

47. The system of claim 42, wherein the source media type comprises an image media type, and the destination media type is selected from a group consisting of: video, text, slide presentation, and audio.

48. The system of claim 42, wherein the source media type comprise an audio media type and the destination media type is selected from a group consisting of: video, text, slide presentation and image.
